(19) United States
(12) Patent Application Publication
(10) Pub. No.: US 2005/0151694 A1
(43) Pub. Date: Jul. 14, 2005

(54) Notched slot antenna

(75) Inventor: Ta-Chih Huang, Hsinchu (TW)

Correspondence Address: BACON & THOMAS, PLLC, 625 SLATERS LANE, FOURTH FLOOR, ALEXANDRIA, VA, 22314, US

(73) Assignee: EMTAC TECHNOLOGY CORP., Hsinchu (TW)

(21) Appl. No.: 11/013,459

(22) Filed: Dec. 17, 2004

(30) Foreign Application Priority Data
Jan. 13, 2004 (TW) 093100746

(51) Int. Cl. H01Q 13/10

(52) U.S. Cl. 343/767; 343/700 MS

(57) ABSTRACT

The present invention is to provide a notched slot antenna, which includes a dielectric substrate, a metal grounding face, which is printed on one side of the dielectric substrate and has a notched slot at one side, and an antenna pattern, which is formed of a main radiator with a signal entrance at one end and a plurality of sub-radiators extended from two sides of the main radiator on the dielectric substrate corresponding the notched slot and spaced from the inner side of the notched slot at a distance.

### BACKGROUND OF THE INVENTION

1. Field of the Invention

The present invention relates to an antenna and more particularly, to a notched slot antenna.

2. Description of Related Art

Conventional bluetooth or 802.11b wireless communication apparatus commonly use an inverted L-type antenna 10 (see FIG. 1). However, in order to reduce the size and to have the power terminal (namely, the signal entrance) 11 obtain sufficient impedance matching, short-circuit means may be provided near the power terminal 11 and the horizontal part in parallel to the metal grounding face 12 may be made in the form of a flat plate, thereby forming an inverted F-type antenna. FIG. 2 shows an inverted L-type panel antenna 20 installed in a circuit board 26. The inverted F-type panel antenna 20 has the antenna circuit panel (antenna pattern) 23 arranged in parallel to and spaced above the metal grounding face 22, and one end 24 angled and connected to the metal grounding face 22 to form a short-circuit. The other end 25 of the inverted F-type panel antenna 20 is maintained in an open-circuit relationship relative to the metal grounding face 22. Further, a power terminal 21 (signal entrance) is provided near the short-circuit. The antenna circuit panel (antenna pattern) 23 of the inverted F-type panel antenna 20 is designed to be about λ/4 (one fourth of the wavelength). When electric current passing the λ/4 (one fourth of the wavelength) path, a resonant radiation is produced. However, due to the limitation of the antenna structure, the gain of the inverted F-type panel antenna 20 is not high, about 0˜2 dB, and the bandwidth is only about 10 MHz at −10 dB.

When installed an inverted F-type antenna having the length about 24.42 mm in a dielectric substrate having the thickness about 0.8 mm and dielectric coefficient about 4.3˜4.6 to make a test sample of inverted F-type panel antenna 20 in which the metal grounding face 22 has a width about 40 mm and a length about 70.16 mm and the antenna circuit panel (antenna pattern) 23 is maintained spaced from the metal grounding face 22 at about 6.3 mm, a test result can be obtained as shown in FIG. 3. The test result shows the bandwidth is about 100 MHz when gain value is −10 dB. Further, when had the inverted F-type panel antenna 20 and the metal grounding face 22 made on the circuit board 26 of a bluetooth or 802.11b wireless communication apparatus and then tested the finished product, the test result shows the bandwidth about 100 MHz at gain value −10 dB, and the gain value about 2 dB, as shown in FIG. 4.

In order to obtain a relatively wider bandwidth and higher gain value, some bluetooth or 802.11b wireless communication apparatus manufacturers use a slot antenna in their products. A slot antenna, as shown in FIG. 5, has a microstrip antenna circuit 30 arranged on the circuit board 36 within a slot 37 at the metal grounding face 32 of the circuit board 36. The microstrip antenna circuit 30 is kept spaced from the inner side of the slot 37 at a distance. This design enables the microstrip antenna circuit 30 to have a relatively wider bandwidth. However, the slot 37 must be made relatively greater if a relatively wider bandwidth is desired. In order to provide sufficient installation space for the microstrip antenna circuit 30, the wireless communication apparatus cannot be made lighter, thinner, shorter and smaller.

In order to make the wireless communication apparatus lighter, thinner, shorter and smaller, manufacturers may install a ceramic antenna 40 having a meander microstrip 43 in the circuit board 46 within the slot 47 at the metal grounding face 42 and keep the ceramic antenna 40 spaced from the inner side of the slot 47 at a distance, as shown in FIG. 6. This design obtains a wide bandwidth and requires less circuit board space. However, the manufacturing cost of this structure of ceramic antenna is high. After installation, a calibration procedure is necessary.

### SUMMARY OF THE INVENTION

The present invention has been accomplished under the circumstances in view. According to the present invention, the notched slot antenna comprises a dielectric substrate, a metal grounding face printed on one side of the dielectric substrate, which metal grounding face having a notched slot at one side, and an antenna pattern formed on the dielectric substrate corresponding the notched slot and spaced from the inner side of the notched slot at a distance. The antenna pattern comprises a signal entrance, a main radiator extended from the signal entrance to a predetermined distance, and a plurality of sub-radiators extended from the main radiator at two sides. According to the present invention, every sub-radiator represents one bandwidth, therefore the bandwidth and gain of the antenna can be adjusted by changing the number and length of the sub-radiators. Further, after design of the desired antenna pattern, the antenna pattern can be directly printed on the dielectric substrate of a circuit board for bluetooth or 802.11b wireless communication apparatus by means of microstrip during the fabrication of the circuit board. Therefore, the antenna can be directly formed on the circuit board of a bluetooth or 802.11b wireless communication apparatus to reduce the manufacturing cost.

The above and other objects, features and advantages of the present invention will become apparent from the following detailed description taken with the accompanying drawings.

### BRIEF DESCRIPTION OF THE DRAWINGS

FIG. 1 is a schematic drawing showing a conventional inverted L-type antenna.

FIG. 2 is a schematic drawing showing a conventional inverted F-type panel antenna.

FIG. 3 is a test result chart made on the inverted L-type antenna in FIG. 1, showing the bandwidth about 100 MHz at gain value −10 dB.

FIG. 4 is a test result chart made on the inverted F-type panel antenna in FIG. 2, showing the bandwidth about 100 MHz at gain value −10 dB.

FIG. 5 is a schematic drawing showing a conventional slot antenna.

FIG. 6 is a schematic drawing showing the meander microstrip of a conventional ceramic antenna/

FIG. 7 is a schematic drawing showing a notched slot antenna according to the present invention.

FIG. 8 is a test result chart made on a notched slot antenna test sample according to the present invention, showing the bandwidth about 800 MHz at gain value −10 dB.

FIG. 9 is a test result chart made on a finished product of notched slot antenna according to the present invention, showing the bandwidth about 800 MHz at gain value −10 dB.

FIG. 10 is a test result chart made on a notched slot antenna according to the present invention, showing the center frequency 3.4 GHz, the bandwidth 2.38 GHz when BW/fo about 70%.

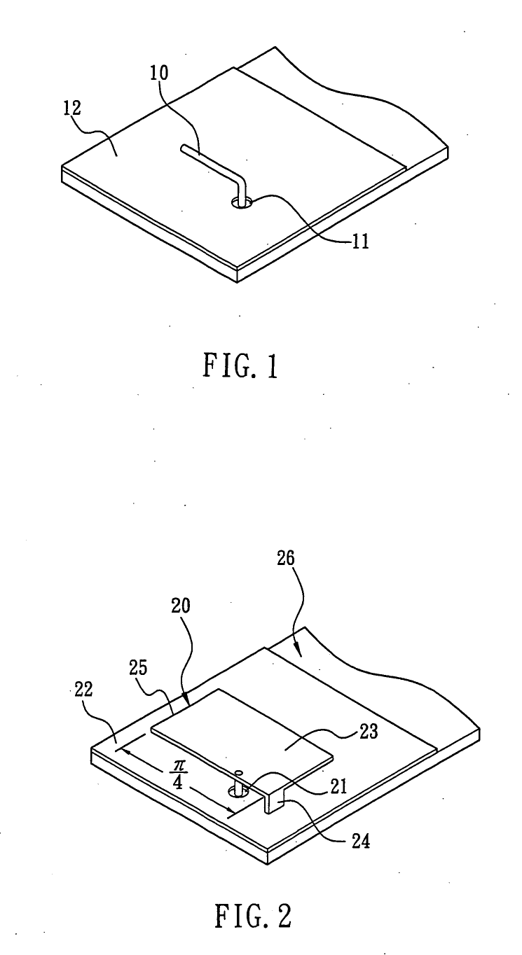

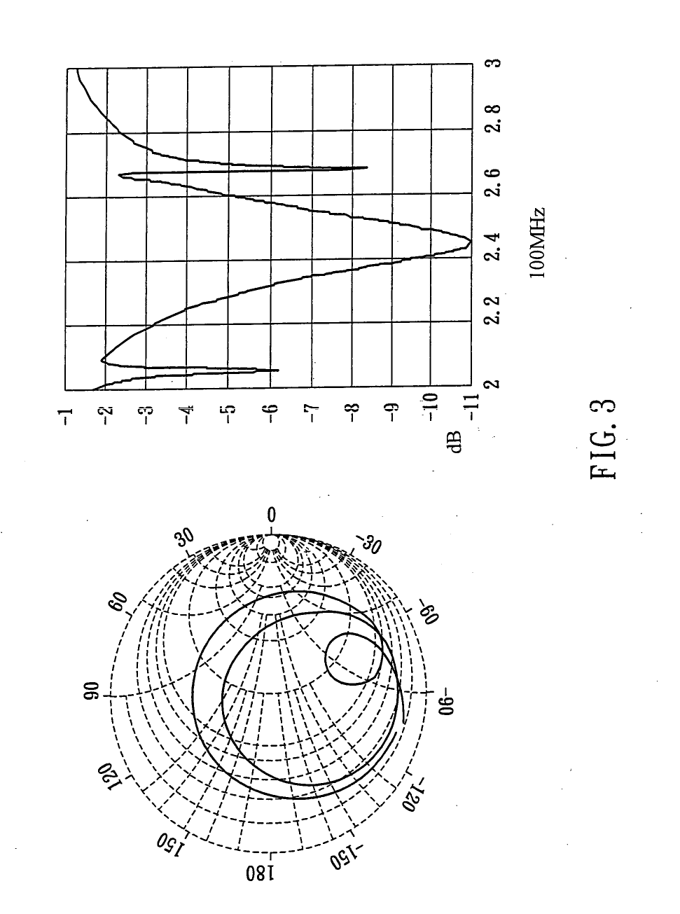

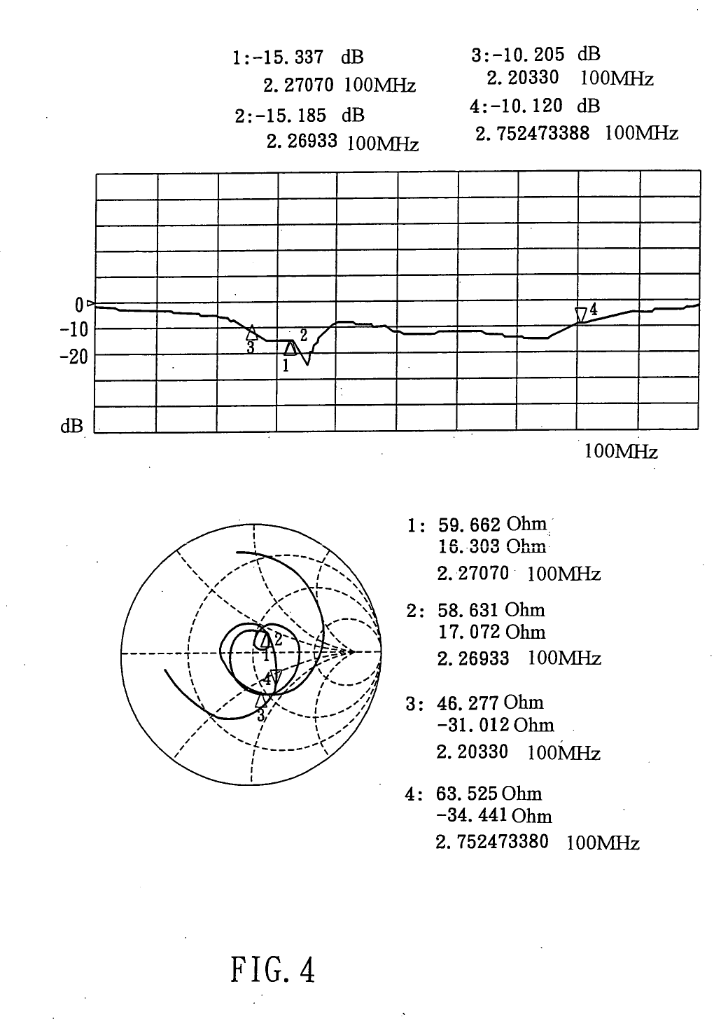

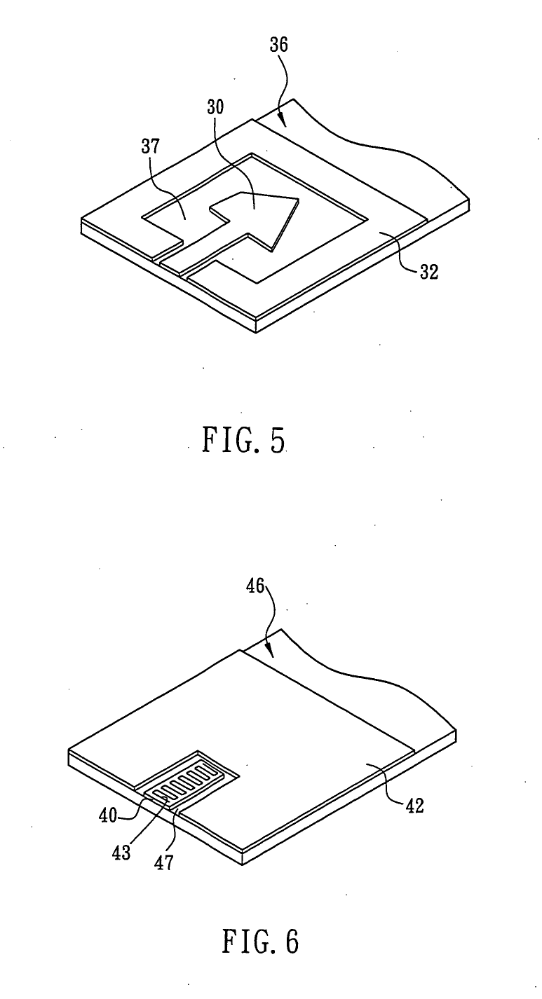

### DETAILED DESCRIPTION OF THE PREFERRED EMBODIMENT

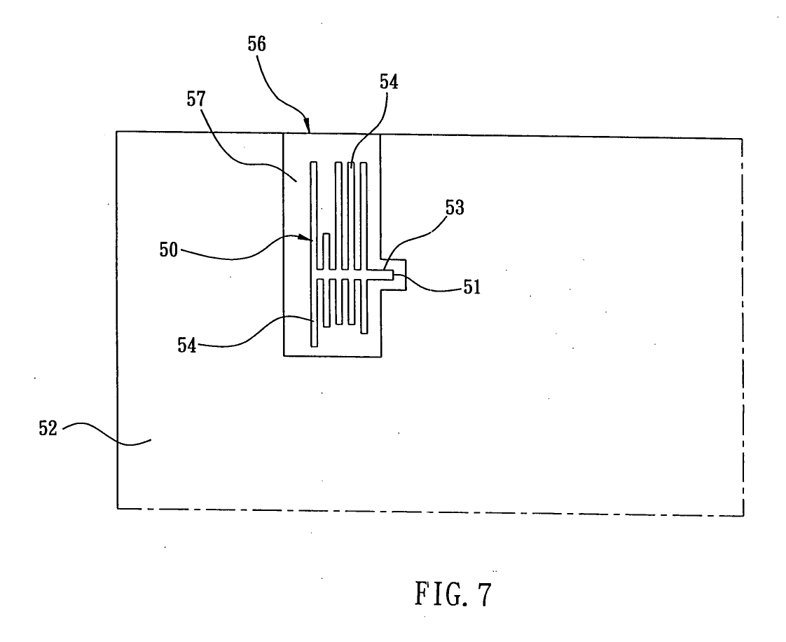

Referring to FIG. 7, a notched slot antenna 50 is made on a circuit board of a bluetooth or 802.11b wireless communication product. The notched slot antenna 50 is arranged on a dielectric substrate 56 of the circuit board. The dielectric substrate 56 has one side thereof printed with a metal grounding face 52 and the necessary circuit pattern (not shown). The metal grounding face 52 has a notched slot 57 at one side to expose the beneath dielectric substrate 56. The microstrip of the notched slot antenna 50 is fixedly made on the dielectric substrate 56 corresponding to the notched slot 57 by printing or a suitable coating method. The microstrip of the notched slot antenna 50 is maintained spaced from the inner side of the notched slot 57 at a distance.

Referring to FIG. 7 again, the microstrip of the notched slot antenna 50 comprises a main radiator 53, a signal entrance 51 at one end of the main radiator 53, a plurality of sub-radiators 54 perpendicularly extended from the main radiator 53 at two sides and forming with the main radiator 53 a fishbone-like antenna pattern. The sub-radiators 54 determine the impedance matching of the notched slot antenna 50, each representing one bandwidth frequency. Therefore, the greater the number of the sub-radiators 54 is the wider the bandwidth will be. Sub-radiators 54 relatively closer to the left side of the notched slot antenna 50 in FIG. 7 control a respective relatively lower frequency due to long electric current path. On the contrary, sub-radiators 54 relatively closer to the right side of the notched slot antenna 50 in FIG. 7 control a respective relatively higher frequency due to short electric current path.

Further, according to experiments, the center frequency fo will be relatively reduced when increasing the number of the sub-radiators 54 in the notched slot antenna 50, however the amount of such variation is not significant. Therefore, in actual fabrication of the notched slot antenna 50, the number and length of every sub-radiator 54 of the test sample is adjusted and tested step by step to obtain the desired antenna pattern. When the desired antenna pattern is obtained, it is formed on the dielectric substrate 56 corresponding to the notched slot 57 to finish the fabrication of the notched slot antenna 50. Thus, no further installation of other components or calibration is necessary in posterior manufacturing process. Therefore, the invention greatly simplifies the fabrication of the notched slot antenna 50 and reduces its manufacturing cost.

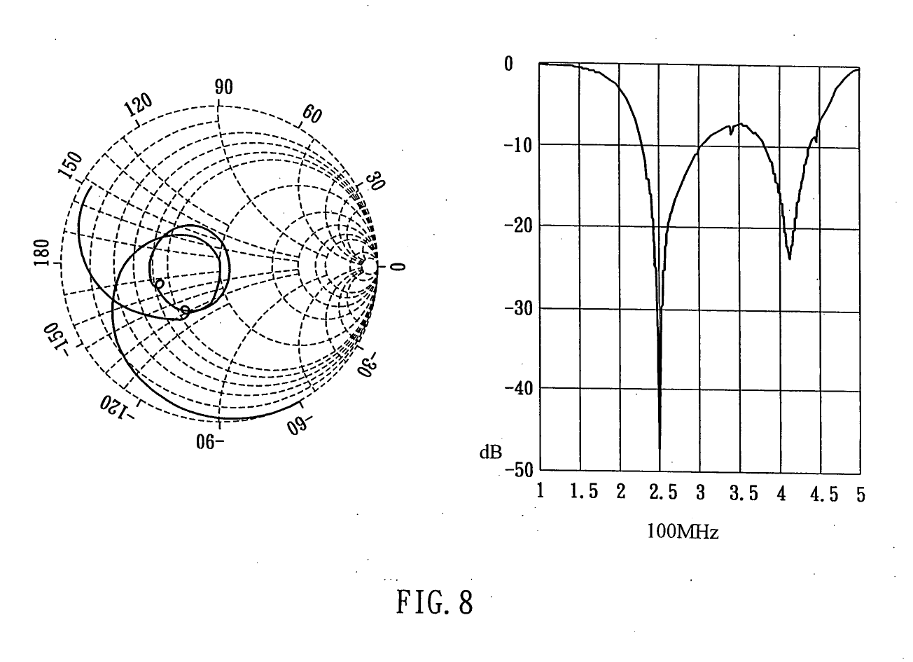

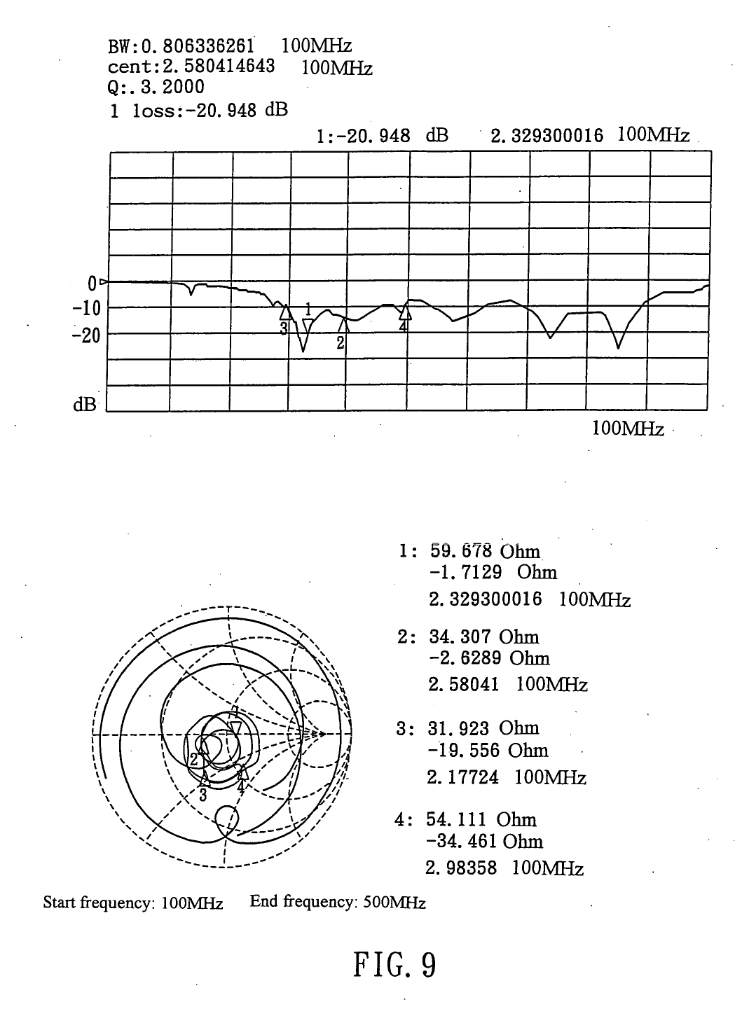

During actual practice, the main radiator 53, the sub-radiators 54 and the metal grounding face 52 of the antenna structure shown in FIG. 7 are printed on a flat dielectric substrate having a thickness about 0.8 mm and dielectric coefficient about 4.3˜4.6, making a test sample wherein the metal grounding face 52 has a width about 44.8 mm, a length about 74.6 mm, and a notched slot 57 having a width about 7.8 mm and a depth about 17.9 mm deep formed in one long side of the metal grounding face 52 at a location spaced from one short side of the metal grounding face 52 at about 13.35 mm. Thus, the antenna 50 is arranged within the notched slot 57 and spaced from the inner side of the notched slot 57 at a distance. The main radiator 53 has one end terminating in a signal entrance 51, which extends to a predetermined distance in parallel to the notched slot 57. In this sample, there are 10 sub-radiators 54 extended from two sides of the main radiator 53 and forming with the main radiator 53 a fishbone-like antenna pattern. Thereafter, the number and length of the sub-radiators 54 of the test sample are adjusted and tested, thereby obtaining the desired antenna pattern as shown in FIG. 7. FIG. 8 shows the test result made on this test sample. As indicated, the bandwidth is about 800 MHz when gain value is about −10 dB. Thereafter, the main radiator 53, the sub-radiators 54 and the metal grounding face 52 are printed on the circuit board of the bluetooth or 802.11b wireless communication apparatus subject to the antenna pattern shown in FIG. 7, and then the finished product is tested. FIG. 9 shows a test result on a finished product made according to the aforesaid procedure. As illustrated in FIG. 9, the bandwidth is about 800 MHz when gain value is about −10 dB; the gain value is about 4.2 bD.

According to the aforesaid test result, the notched slot antenna 50 of the present invention has the wideband characteristics of regular slot antenna; the bandwidth can be about 30% wider than conventional slot antennas; the slot 57 in the metal grounding face 52 can be 10% smaller than conventional slot antennas or reversed F-type panel antennas. The average gain value of the present invention is about 3˜5 dBi, greater than 2 dB of conventional inverted F-type panel antennas.

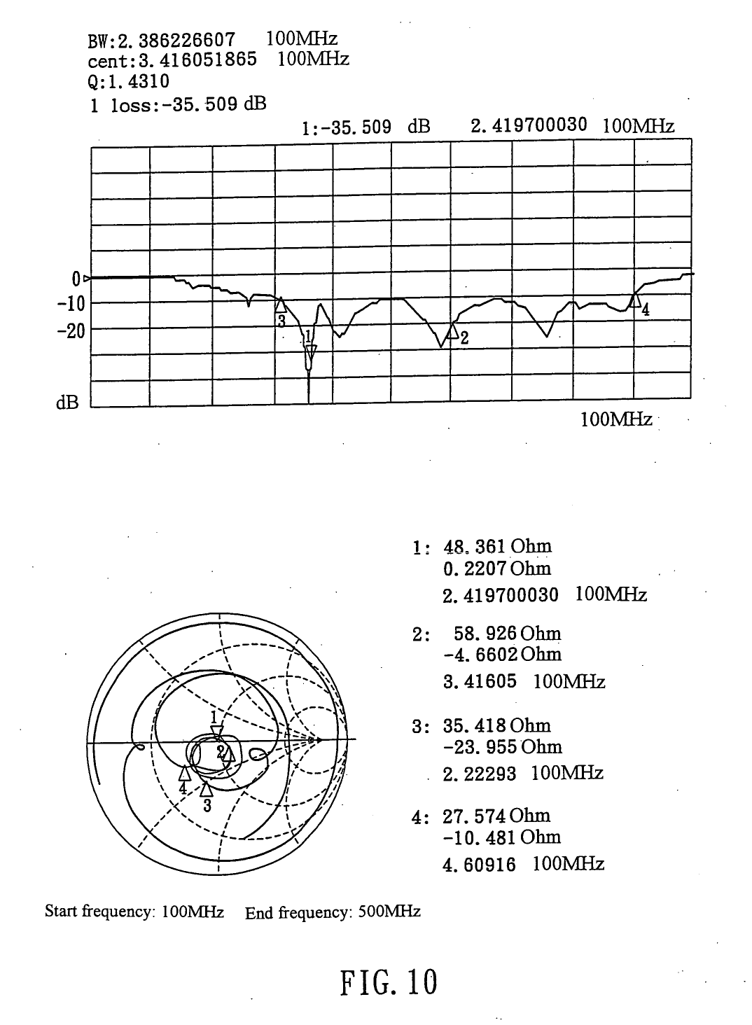

Further, repeated test shows that the main radiator 53 and sub-radiators 54 of the notched slot antenna 50 of the present invention determine the impedance matching of the antenna, and the width and depth of the notched slot 57 determine the center frequency fo of the antenna. Therefore, the deeper the notched slot 57 is the lower the center frequency fo will be. According to the present invention, a test was made on each change of the size of the metal grounding face 52, and the test result is shown in FIG. 10. As illustrated in FIG. 10, the impedance matching and bandwidth of the antenna varies with the size of the metal grounding area 52; the center frequency fo is 3.4 GHz; the bandwidth is 2.38 GHz when BW/fo is about 70%. Therefore, properly adjusting the number of the sub-radiators 50 and the size of the main radiator 53, sub-radiators 50 and metal grounding face 52 can obtain an ultra bandwidth antenna, providing relatively wider bandwidth and higher gain value under a relatively smaller notched slot 57.

Although the present invention has been explained in relation to its preferred embodiment, it is to be understood that many other possible modifications and variations can be made without departing from the spirit and scope of the invention as hereinafter claimed.

1. A notched slot antenna comprising a dielectric substrate, a metal grounding face printed on one side of said dielectric substrate, said metal grounding face having a notched slot at one side thereof, an antenna pattern formed on said dielectric substrate corresponding said notched slot and spaced from an inner side of said notched slot at a distance, said antenna pattern comprising a signal entrance, a main radiator extended from said signal entrance to a predetermined distance, and a plurality of sub-radiators extended from two sides of said main radiator.

2. The notched slot antenna as claimed in claim 1, wherein said main radiator extends from said signal entrance to a predetermined distance in a direction parallel to said notched slot.

3. The notched slot antenna as claimed in claim 2, wherein said sub-radiators are perpendicularly extended from two sides of said main radiator.

4. The notched slot antenna as claimed in claim 3, wherein antenna pattern is printed on said dielectric substrate corresponding to said notched slot by means of microstrip.

5. The notched slot antenna as claimed in claim 3, wherein said antenna pattern is fixedly mounted on said dielectric substrate corresponding to said notched slot by means of microstrip.
